(19) United States
(12) Patent Application Publication
(10) Pub. No.: US 2007/0095733 A1
(43) Pub. Date: May 3, 2007

(54) Vibration dampening double filter for fuel pump

(75) Inventors: Giuseppe Pizzo, Wyandotte, MI (US); Patrick K. Powell, Farmington, MI (US)

Correspondence Address: HARNESS, DICKEY & PIERCE, P.L.C., P.O. BOX 828, BLOOMFIELD HILLS, MI, 48303, US

(73) Assignee: DENSO International America, Inc.

(21) Appl. No.: 11/265,220

(22) Filed: Nov. 2, 2005

(51) Int. Cl. B01D 35/26

(52) U.S. Cl. 210/172.4; 210/416.4

(57) ABSTRACT

A fuel pump having double filter elements that contact the fuel pump module reservoir wall will dampen vibrational energy that originates in the fuel pump and propagates through the filter elements and into the fuel pump module reservoir. The fuel filter apparatus situated within the fuel pump module reservoir has a fuel pump with a fuel filter carrier attached to an end of the fuel pump. The fuel filters that attach to the fuel filter carrier are doubled such that one lies over the other in an over-lapping or sock-like arrangement. The outside filter presses against the wall of the fuel pump module reservoir to dampen any vibration that propagates from the fuel pump. The fuel filters lie under the fuel pump in such a way that they are between the fuel pump and the fuel pump module wall with which they make contact.

### FIELD OF THE INVENTION

The teachings of the present invention relate to a vibration dampening filter for a fuel pump. More specifically, the teachings of the present invention relate to a double filter for a vertically or horizontally mounted fuel pump.

### BACKGROUND OF THE INVENTION

Modern automobile fuel supply systems are generally suitable for their applications; however, each is associated with its share of problems. Most automobiles have a fuel tank in the rear of the vehicle, located just aft of the rear wheels. The fuel tank has a fuel pump module situated within a fuel pump module reservoir. The fuel pump module utilizes an electric fuel pump that generates vibrational sound energy when it is engaged in pumping. The vibrational energy propagates from the fuel pump in various directions before it reaches the ear of a vehicle occupant or a person standing outside of the vehicle.

In one instance, the vibrational energy travels from the fuel pump, into a rigid fuel filter carrier attached to the fuel pump, through the fuel filter which is supported by the rigid carrier, and into the wall of the fuel pump module reservoir. Since the reservoir is held against the inside bottom surface of the fuel tank, noise propagates into the fuel tank wall and then into other parts of the vehicle that contact the tank and also into the area surrounding the vehicle. In both instances, the noise may be at such a level to be heard by a person.

In another instance, the vibrational energy travels from the fuel pump, and into the liquid fuel within the fuel pump module reservoir. The noise propagating through the liquid fuel then propagates into the wall of the fuel pump module reservoir at various locations of the fuel pump module reservoir. Since the reservoir is held against the inside bottom surface of the fuel tank, noise reflecting off of the fuel pump module reservoir walls will travel through the reservoir walls and propagate into the fuel tank wall and then into other parts of the vehicle that contact the fuel tank and also into the areas surrounding the vehicle. In both instances, the noise may be at such a level to be heard by a person.

A need exists then for a fuel pump module that does not suffer from the above limitations. This in turn, will result in a vibration dampening double filter for a fuel pump that dampens vibrational sound energy encountering or passing through the fuel filter from any direction and that reduces or eliminates vibrational sound energy that otherwise may be heard by vehicle occupants or bystanders.

### SUMMARY OF THE INVENTION

A fuel pump module has a reservoir and a fuel pump located within the reservoir. The fuel pump has a double filter, that is, a first filter element that is wrapped around a rigid carrier and a second filter that is wrapped around the first filter element. The carrier is connected to an end of the fuel pump. The outside filter contacts the fuel pump module reservoir wall and dampens vibrational sound energy that originates in the fuel pump and propagates through the carrier and into the fuel pump module reservoir walls. The double filter also absorbs vibrational sound energy that propagates through the liquid fuel and into the fuel pump module reservoir wall via the fuel filters. The fuel filters that attach to the fuel filter carrier are doubled such that one lies over the other in an over-lapping or sock-like arrangement. The outside filter presses against the fuel pump module reservoir wall and dampens any vibrational energy that propagates from the fuel pump. The fuel pump and the outside filter may or may not define a gap. The fuel filters lie under the fuel pump in such a way that they are between the fuel pump and the fuel pump module reservoir wall with which they make contact.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a side view of a vehicle depicting its fuel system in phantom;

FIG. 2 is a perspective view of a fuel pump module and reservoir according to teachings of the present invention;

FIG. 3 is a side view of a fuel tank and fuel pump module depicting a vertical fuel pump and accompanying filters in phantom according to teachings of the present invention;

FIG. 4 is a side view of a fuel tank and fuel pump module depicting a horizontal fuel pump and accompanying filters in phantom;

FIG. 5 is side view of a circular double filter before welding the filter elements in their final position according to the teachings of the present invention;

FIG. 6 is a top view of the circular double filter before welding the filter elements in their final position according to the teachings of the present invention;

FIG. 7 is a bottom view of the circular double filter before welding the filter elements in their final position according to the teachings of the present invention;

FIG. 8 is a top view of the circular double filter after welding the filter elements according to the teachings of the present invention;

FIG. 9 is a side view of an elongated double filter depicting both filter elements after welding according to the teachings of the present invention;

FIG. 10 is a side view of the elongated double filter depicting the first, inner filter element before placement and welding of the outer filter element according to the teachings of the present invention;

FIG. 11 is a side assembly view of the elongated double filter depicting how the outer filter installs over the inner filter; and

FIG. 12 is a top view of the elongated double filter depicting both filter elements after welding according to the teachings of the present invention.

### DETAILED DESCRIPTION OF THE PREFERRED EMBODIMENTS

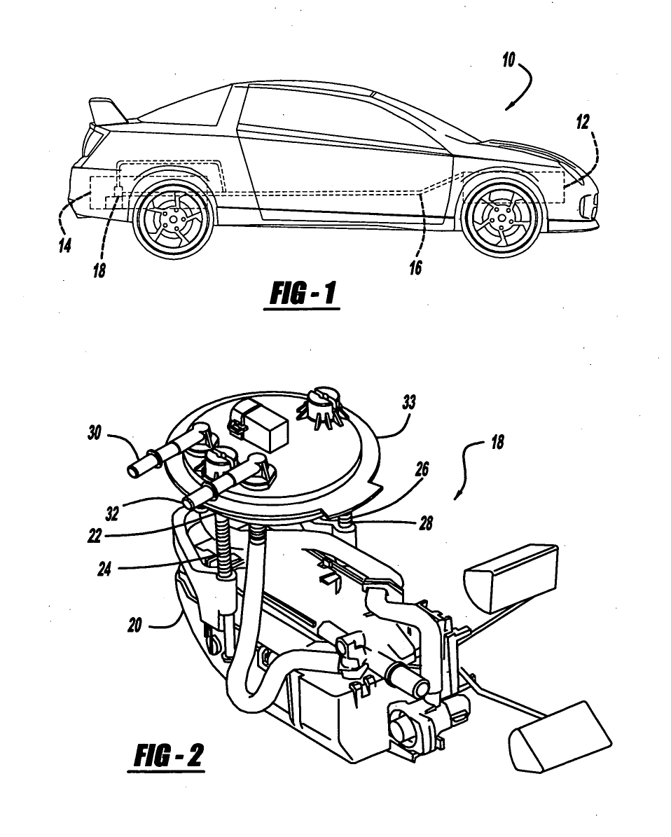

The following description of the preferred embodiments is merely exemplary in nature and is in no way intended to limit the invention, its application, or uses. Turning now to the teachings of the present invention, FIGS. 3 through 12 depict a vibration dampening double filter for a fuel pump. Because such a double filter resides within a reservoir 20 of a fuel pump module 18, an explanation of the filters' surroundings will be presented. FIG. 1 depicts an automobile 10 that houses a fuel pump module 18 within a fuel tank 14 located in the rear of the vehicle 10. A fuel pump of the fuel pump module 18 pumps fuel from the fuel tank 14 through a fuel line 16 to the front of the vehicle 10 to an engine 12.

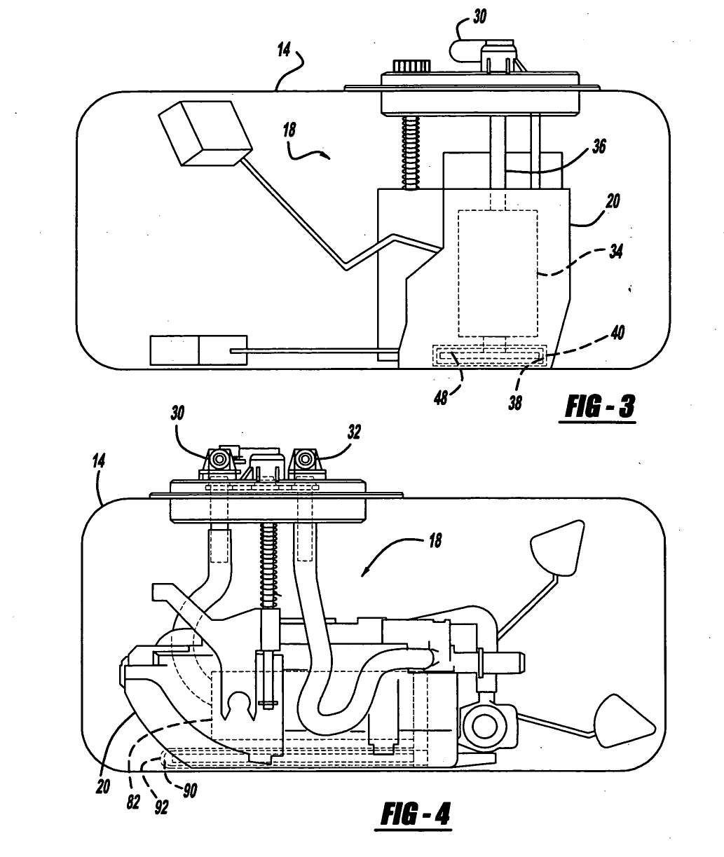

FIG. 2 depicts a fuel pump module 18 having a fuel pump module reservoir 20 and a fuel pump module flange 33. The flange 33 holds a fuel outlet 30 and a fuel inlet 32 of the fuel pump module 18. Additionally, the flange 33 secures a first strut 22 having a first strut spring 24, and a second strut 26 having a second strut spring 28. The first strut spring 24 and second strut spring 28 bias the reservoir 20 against the bottom of the fuel tank 14, as depicted in FIGS. 3 and 4.

FIGS. 3 and 4 depict alternate arrangements of the vibration dampening double filter for a fuel pump according to the teachings of the present invention. FIG. 3 depicts a vertically arranged fuel pump 34 while FIG. 4 depicts a horizontally arranged fuel pump 82. Turning to FIG. 3, and FIGS. 5 through 8, a more detailed explanation of the vertical fuel pump 34 having a vibration dampening double filter will be explained. The vertical fuel pump 34 depicts a rigid filter carrier 48, an inner filter 38, and an outer filter 40. As depicted in FIG. 3, the outer filter 40 contacts the bottom inside surface of the fuel pump module reservoir 20. The bottom outside surface of the fuel pump module reservoir 20 contacts the bottom inside surface of the fuel tank 14. This is one arrangement through which vibration sound dampening is able to take place.

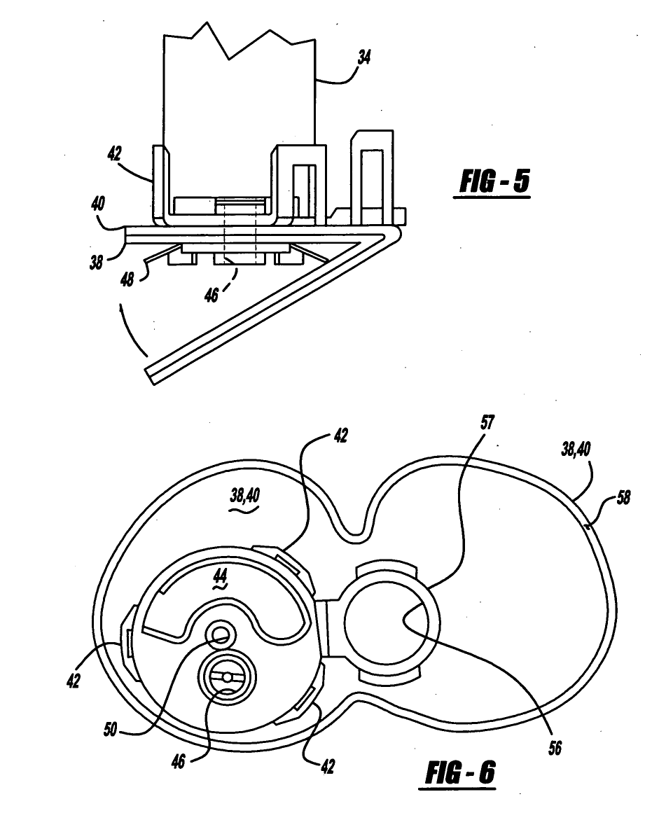

With continued reference to FIG. 3, and FIGS. 5 through 8, the fuel pump 34 is press-mounted into fuel pump mount 44 and surrounded by the fuel filter guides 42, which are part of the filter carrier 48 as depicted in FIG. 5. The fuel filter guides 42 and the carrier 48, although a single structural piece, are also linked by a fuel pump inlet 46 defined through the carrier 48. The carrier 48 secures the inner fuel filter 38 and the outer fuel filter 40 below and adjacent the fuel filter 34. As depicted in FIGS. 6 and 7, the inner fuel filter 38 and outer fuel filter 40 are each a single piece of gradient density (GD) filter material. The hour-glass or double-circular or near double-circular shape of the material depicted in FIG. 6 is folded to create the overall thickness of four gradient density layers. Each gradient density layer of filter material is itself a multi-layer structure. Each sub-layer of the inner filter 38, for example, is capable of filtering a different size of particulate matter from fuel passing through the filter 38. A multitude of different filter materials having various filter qualities are possible, that is, the size of the pores in the filter material can vary between layers to provide the desired filter characteristics.

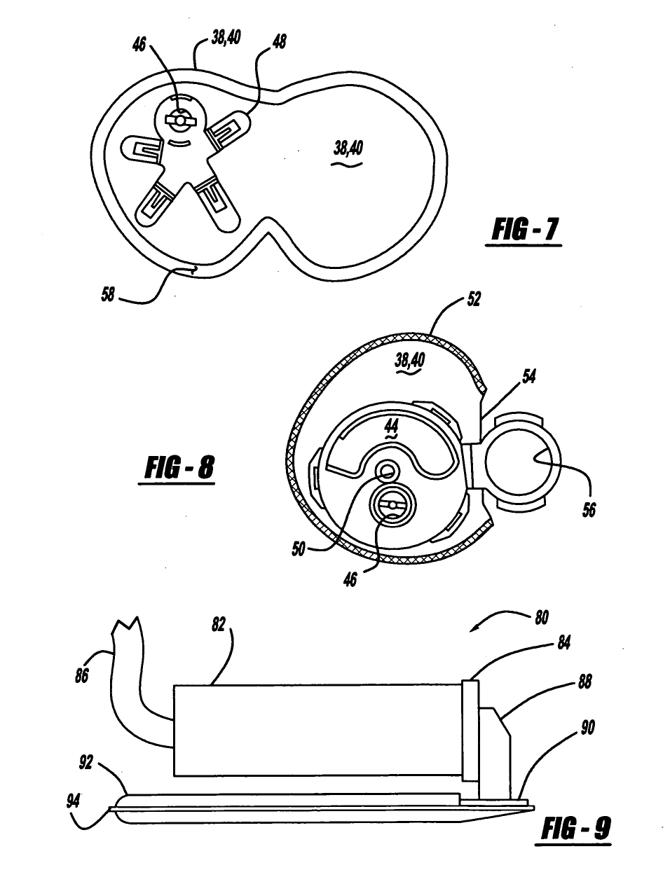

Continuing with the vertical fuel filter 34, when the inner fuel filter 38 and outer fuel filter 40 are folded over, they are welded about the periphery of the newly formed circular or near circular shape, as depicted in FIG. 8. FIG. 6 depicts the filter structure in its as-cut geometry, prior to folding and welding. The weldable area 58 is also shown, as depicted in FIGS. 6 and 7.

FIG. 6 is a top view depicting the carrier with its fuel pump mount 44, its fuel pump inlet 46, and fuel pump alignment hole 50. The fuel pump 34 has a projection (not shown) that press fits into the fuel pump mount 44. The fuel filter guide 42 helps guide the fuel pump 34 during installation and helps to secure the fuel pump 34 after its press-fitting into the fuel pump mount 44. When the fuel pump 34 is properly installed in the carrier 48, an alignment peg (not shown) of the fuel pump 34 becomes lodged within the fuel pump alignment hole 50. Additionally, a fuel regulator alignment hole 56 resident in a fuel regulator holder 57 secures a fuel regulator (not shown) located adjacent to the fuel pump 34. The fuel regulator holder 57 is an integral part of the carrier 48.

FIG. 7 is a bottom view of the circular double filter 38, 40 before welding the filter elements 38, 40 together. FIG. 7 depicts the carrier 48 that defines the fuel pump inlet 46. Additionally, the arm and leg structure of the carrier 48 is depicted, which permits the carrier 48 to provide a space between the folded layers of the inner fuel filter 38. This space helps facilitate the flow of fuel from the reservoir 20, through the filters 38, 40 and into the fuel pump inlet 46 so that the fuel pump 34 can be continuously supplied with fuel. FIG. 7 depicts the fuel pump inlet 46 located within the arm and leg arrangement of the carrier 48. The positioning of the fuel pump inlet is in the space or gap created by the arms and legs when the filters 38, 40 are welded. Also depicted in FIGS. 6 and 7 is the weldable area 58, which becomes the welded area 52 upon welding the inner fuel filter 38 and outer fuel filter 40 as depicted in FIG. 8, which will now be discussed.

FIG. 8 depicts a top view of the near circular double filter 38, 40 after welding the filter elements 38, 40 according to the teachings of the present invention. To arrive at the completed filter depicted in FIG. 8, a portion of the filter structure 38, 40 of FIG. 6 is folded under the fuel regulator holder 57 as depicted in FIG. 5 by the directional arrow. The filter elements 38, 40 are folded about a fold 54 to create the clam-like structure. The welding of the filter elements 38, 40 about weldable area 58 is accomplished by subjecting the weldable area 58 to heat with an iron or between platens, for example, or another suitable heating element.

In another embodiment according to the teachings of the present invention, a horizontal filter and fuel pump arrangement 80 is depicted in FIG. 9. A horizontal fuel pump 82 lies parallel to an inner fuel filter 90 and an outer fuel filter 92, which lie below the fuel pump 82, when it is installed in the fuel reservoir 20. The inner fuel filter 90 and outer fuel filter 92 are welded together as indicated by the weld area 94. The horizontal fuel pump 82 is attached to a fuel pump mount 84 that has a fuel inlet tube 88. The fuel pump mount 84 has the same fuel pump mount 44, alignment hole 50, and fuel pump inlet 46 as that depicted in FIG. 8. The fuel inlet tube 88 draws fuel from the filter carrier 96, which is surrounded by the fuel filters 90, 92 and delivers the fuel through the fuel pump mount 84, out of the fuel outlet port 100 (FIG. 12), and into the fuel pump 82. The fuel pump 82 then pumps the drawn fuel into the fuel outlet line 86 so that fuel is delivered through the fuel outlet 30 adjacent the flange 33 and into the fuel line 16 to the engine 12.

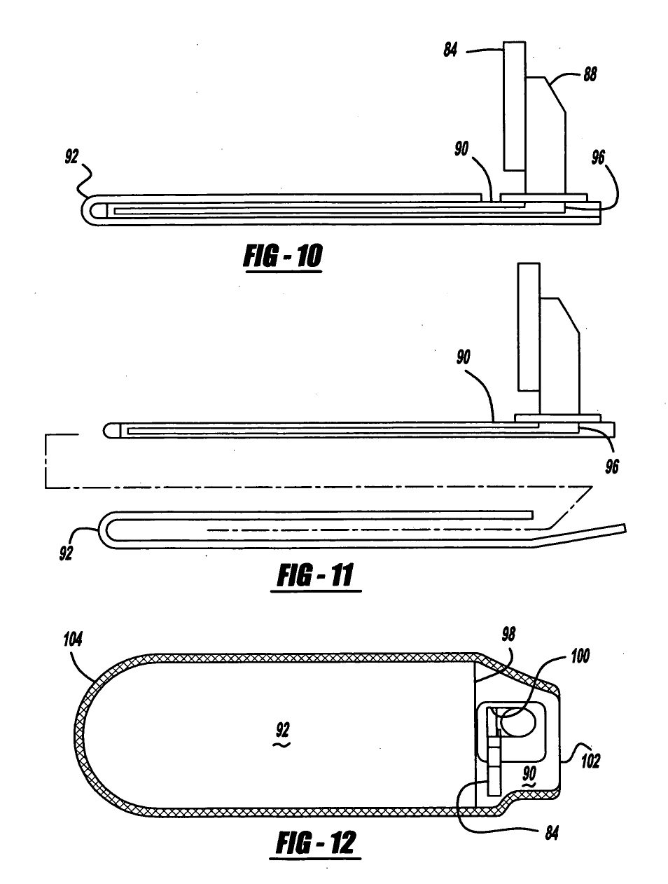

Continuing with reference to FIGS. 9 through 12, the inner fuel filter 90 is placed over the filter carrier 96, which is an elongated piece of rigid material, such as plastic. The outer filter 92 slides over the inner filter 90 as depicted in FIG. 11 to form a double filter over the carrier 96. Upon positioning of the sock-like outer filter 92, the outer filter 92 and inner filter 90 are welded together about the periphery 104 of the double filter arrangement. The outer filter 92 has a top outer filter edge 98 that lies just in front of and adjacent to the fuel pump mount 84. The outer filter 92 also has a bottom outer filter edge 102. These areas are not welded after the sock-like outer filter 92 is slid over the inner filter 90 and into position.

Now, an explanation of vibrational sound dampening, as it relates to the teachings of the present invention, will be provided. Although appropriate fuel filtering and some vibrational dampening results from the use of a single gradient density (GD) filter material, uses a double filter 38,40 provides a dual filter and increased dampening of audible vibrational energy that emanates from the fuel pump 34, 82. For instance, in the vertical fuel pump arrangement of FIG. 3, the inner filter 38 and outer filter 40 each provide a layer of filter material that dampens audible vibrational energy that emanates from the fuel filter 34. In a first example, audible vibrational energy emanates from the fuel pump 34, through the rigid filter carrier 48, through the filters 38, 40 through the wall of the reservoir 20, through the fuel tank 14, and into the surrounding atmosphere where it may be heard by a person.

Additionally, because the gradient filter material is of a double thickness, the same gradient of audible vibrational dampening is experienced twice when audible vibrations are subjected to the filter, as opposed to a single gradient filter, even one of a thickness equal in thickness to a double thickness. The result of such a structure is that the audible frequencies are subjected to the same gradient density filter material twice, and not just once. This double subjection permits a double trial at dampening the same frequency. This is different than simple providing a thicker material of a continuous gradient design where audible vibrations would only be subjected once to a particular filter gradient material.

In another example, the fuel filter 34 emanates noise that travels through liquid fuel within the reservoir 20, reflects back from the walls of the reservoir 20, through the filters 38, 40, through the wall of the reservoir 20, and through the fuel tank 14 to the atmosphere where it may be heard by a person. In this scenario, only a portion of the vibrational energy will be reflected back from the reservoir walls, while the balance will pass directly through the wall of the reservoir 20.

The horizontal fuel pump arrangement of FIGS. 4 and 9-12 is advantageous in that the longitudinal length of the fuel pump 82 lies adjacent the dual filters 90, 92. Although a gap is defined between the fuel filter 82 and the outer filter 92, the fuel filter 82 could lie against the outer filter 92. The gap provides an additional interface of liquid fuel through which any vibrational energy must travel through before reaching the outer filter 92.

In the above description, the double filter arrangement has been described and shown such that the filters 40, 92 contact the bottom surface of the reservoir 20. It is easily conceivable that the filters 40, 92 in their corresponding vertical and horizontal arrangement, will not contact the wall of the reservoir 20. In such an application, the filters could be suspended above the wall of the reservoir 20. In such an arrangement, an additional interface of liquid fuel would exist between the filters 40, 92 and the reservoir wall 20, thus further impeding the propagation of audible vibrational energy to the atmosphere outside of the fuel tank 14.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A fuel filter apparatus comprising:
a carrier;
a first filter element attached to the carrier; and
a second filter element attached over the first filter element piece.

2. The filter apparatus of claim 1, wherein the second filter element is attached against the first filter element piece.

3. The filter apparatus of claim 1, wherein the first and second filter elements are folded to encapsulate a portion of the carrier.

4. The filter apparatus of claim 1, wherein the first and second filter elements are welded about their periphery.

5. The filter apparatus of claim 1, the carrier further comprising:
an inside carrier portion located inside the first and second filter elements; and
an outside carrier portion located outside the first and second filter elements.

6. The filter apparatus of claim 1, wherein the carrier defines a hole providing a pathway to the interior of the first filter element.

7. The filter apparatus of claim 1, wherein the second filter element slides over the first filter element during installation, the second filter element residing as a sock over the first filter element.

8. The filter apparatus of claim 1, further comprising:
a fuel pump module reservoir, wherein the second fuel filter element abuts against the fuel pump module reservoir.

9. The filter apparatus of claim 1, further comprising:
a fuel pump; and
a fuel pump module reservoir, wherein the first and second filter elements are sandwiched between the fuel pump and the fuel pump module reservoir.

10. A fuel filter apparatus situated within a fuel pump module reservoir, the fuel filter apparatus comprising:
a fuel pump;
a fuel filter carrier attached to the fuel pump; and
a fuel filter attached to the fuel filter carrier, wherein the fuel filter contacts the fuel pump module reservoir.

11. The fuel filter apparatus of claim 10, the fuel filter further comprising:
a first filter element attached to the carrier; and
a second filter element attached over the first filter element piece.

12. The fuel filter apparatus of claim 11, wherein the second filter element slides over the first filter element piece like a sock.

13. The fuel filter apparatus of claim 11, wherein the first and second filter elements lie under the fuel pump.

14. The fuel filter apparatus of claim 10, wherein the fuel filter carrier lies inside the fuel filter.

15. The fuel filter apparatus of claim 10, wherein the fuel filter is situated directly under the fuel pump.

16. A fuel filter apparatus comprising:
a fuel pump module reservoir;
a fuel pump situated within the fuel pump module reservoir;
a fuel filter carrier attached to a first end of the fuel pump; and
a fuel filter attached to a first end of the fuel pump and sandwiched between the fuel pump and the fuel pump module.

17. The fuel filter apparatus of claim 16, wherein the fuel filter further comprises:
a first fuel filter element; and
a second fuel filter element wrapped around the first fuel filter element.

18. The fuel filter apparatus of claim 17, wherein the fuel filter carrier is positioned within the first fuel filter element.

19. The fuel filter apparatus of claim 17, wherein the fuel filter apparatus defines a hole through which fuel is permitted to pass from the fuel filter elements and into the fuel pump.

20. The fuel filter of claim 16, wherein the fuel filter is welded about its periphery to secure it onto the fuel filter carrier.
